(19) United States
(12) Patent Application Publication
(10) Pub. No.: US 2011/0061022 A1
(43) Pub. Date: Mar. 10, 2011

(54) Date-Day Checker

(76) Inventor: Michael A. Reed, Austin, TX (US)

(21) Appl. No.: 12/555,212

(22) Filed: Sep. 8, 2009

(51) Int. Cl. G06F 3/048

(52) U.S. Cl. 715/810

(57) ABSTRACT

A system, method, and computer-usable medium are disclosed for validating weekday and date combinations in electronic text. A target electronic text is processed to identify weekday-date combinations. If a weekday-date combination is identified, then its format is determined and its individual data elements are parsed and then processed to determine whether the weekday-date combination is valid. If not, then a plurality of valid weekday-date combinations are generated from the parsed weekday-date data elements and then displayed to the user within a user interface. The user selects a valid weekday-date combination to replace the invalid weekday-date combination.

### BACKGROUND OF THE INVENTION

1. Field of the Invention

Embodiments of the invention relate generally to information processing systems and in particular to software utilized in this field. More specifically, embodiments of the invention provide a system, method, and computer-usable medium for validating weekday and date combinations in electronic text.

2. Description of the Related Art

The number of electronic documents generated by word processors, email clients, and other software applications continues to grow. It is not unusual for these documents to contain misspelled words, which in many cases are simply the result of one or more “finger slips” by the user. As a result, the use of spellcheckers to correct such misspellings has become increasingly popular in recent years.

Some spellcheckers are used after the document is composed while others provide an auto-correction feature that provides suggested spellings to the user as text is entered into the electronic document. These suggested, or alternative spellings, are often presented to the user in a ranked order, according to the likelihood of what the user had intended to type. In some cases, the spellchecker uses a static or online dictionary or replacement words. In other cases, the spellchecker employs sophisticated algorithms and artificial intelligence approaches to providing the suggested words.

It is also common for users to inadvertently, or mistakenly, write weekday and date combinations that do not agree. Unless corrected, such mismatched combinations of weekdays and dates can confuse a reader. As an example, the user may mistakenly enter “Sunday, Dec. 8, 1941,” instead of “Sunday, Dec. 7, 1941,” when writing an account of the bombing of Pearl Harbor. Conventional approaches to this issue include the use of “weekday calculators.” The user enters a day, month, and year, and the corresponding weekday is generated. However, there is no current equivalent to an integrated spellchecker for checking the validity of weekday and date combinations in electronic documents. As a result, users must manually check their documents for the accuracy of weekday and date combinations, which is tedious, time consuming, and error-prone.

### SUMMARY OF THE INVENTION

A system, method, and computer-usable medium are disclosed for validating weekday and date combinations in electronic text. In various embodiments, a target electronic text is processed to identify weekday-date combinations. In these and other embodiments, the target electronic text is received within a user interface. In one embodiment, the target electronic text has been generated before it is received within the user interface for processing. In another embodiment, the target electronic text is processed as it is entered within the user interface by a user.

If a weekday-date combination is identified, then its format is determined and its individual data elements are parsed and then processed to determine whether the weekday-date combination is valid. If not, then a plurality of valid weekday-date combinations are generated from the parsed weekday-date data elements and then displayed to the user within a user interface. In various embodiments, the valid weekday-date combinations comprise a plurality of different weekday data elements and a plurality of different date data elements. In various other embodiments, the valid weekday-date combinations comprise the same weekday data element and a plurality of different date data elements. In one embodiment, the user selects a valid weekday-date combination to replace the invalid weekday-date combination. In another embodiment, the user manually enters a weekday-date combination within the user interface to replace the invalid weekday-date combination.

### BRIEF DESCRIPTION OF THE DRAWINGS

A system, method, and computer-usable medium are disclosed for validating weekday and date combinations in electronic text. The present invention may be better understood, and its numerous objects, features and advantages made apparent to those skilled in the art by referencing the accompanying drawings. The use of the same reference number throughout the several figures designates a like or similar element.

FIG. 1 is a generalized block diagram illustrating an information processing system as implemented in accordance with an embodiment of the invention;

FIG. 2 is a generalized flowchart of the operation of a weekday-date validation module as implemented in an embodiment of the invention for validating weekday and date combinations in electronic text;

FIG. 3 is a simplified illustration of a weekday-date validation module as implemented within a window of a user interface in accordance with a first embodiment of the invention for validating weekday and date combinations in electronic text; and

FIG. 4 is a simplified illustration of a weekday-date validation module as implemented within a window of a user interface in accordance with a second embodiment of the invention for validating weekday and date combinations in electronic text.

### DETAILED DESCRIPTION

A system, method, and computer-usable medium is disclosed for validating weekday and date combinations in electronic text. Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. Some portions of the detailed descriptions provided herein are presented in terms of algorithms and instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

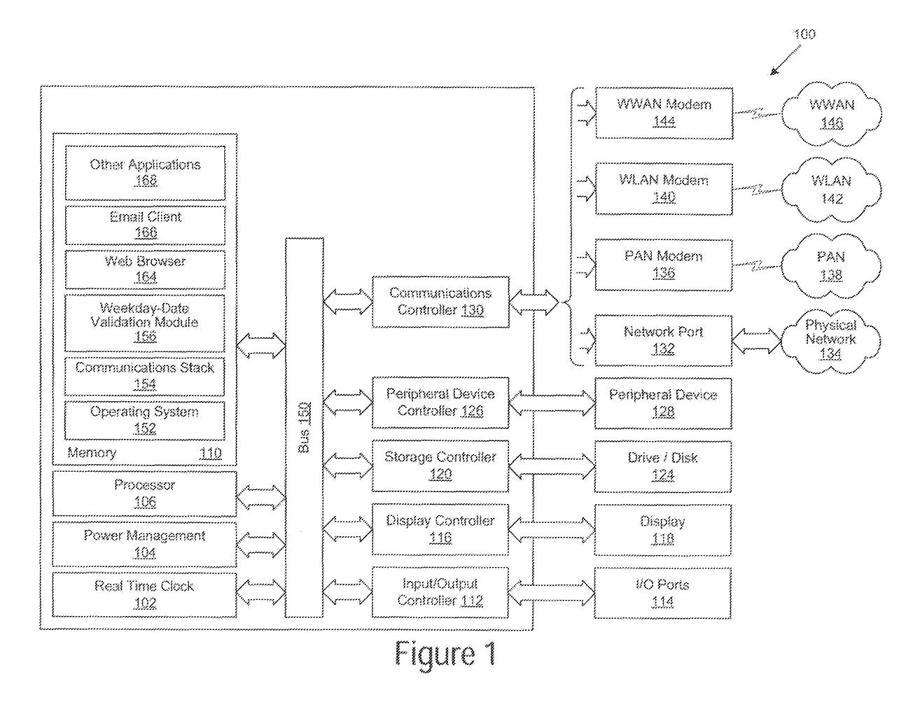

FIG. 1 is a generalized block diagram illustrating an information processing system 100 as implemented in accordance with an embodiment of the invention. System 100 comprises a real-time clock 102, a power management module 104, a processor 106 and memory 110, all physically coupled via bus 150. In different embodiments, memory 110 comprises volatile random access memory (RAM), non-volatile read-only memory (ROM), non-volatile flash memory, or any combination thereof. In one embodiment, memory 110 also comprises an operating system 152, a communications stack 154, a weekday-date validation module 156, a Web browser 164, an electronic mail (email) client 166, and other applications 168.

Also physically coupled to bus 150 is an input/out (I/O) controller 112, further coupled to a plurality of I/O ports 114. In different embodiments, I/O port 114 may comprise a keyboard port, a mouse port, a parallel communications port, an RS-232 serial communications port, a gaming port, a universal serial bus (USB) port, an IEEE1394 (Firewire) port, or any combination thereof. Display controller 116 is likewise physically coupled to bus 150 and further coupled to display 118. In one embodiment, display 118 is separately coupled, such as a stand-alone, flat panel video monitor. In another embodiment, display 118 is directly coupled, such as a laptop computer screen, a tablet PC screen, or the screen of a personal digital assistant (PDA). Likewise physically coupled to bus 150 is storage controller 120 which is further coupled to mass storage devices such as a tape drive or hard disk 124. A peripheral device controller 126 is also physically coupled to bus 150 and further coupled to peripheral device 128, such as a random array of independent disk (RAID) array or a storage area network (SAN).

In one embodiment, communications controller 130 is physically coupled to bus 150 and is further coupled to network port 132. In turn, network port 132 further couples the information processing system 100 to one or more physical networks 134, such as a local area network (LAN) based on the Ethernet standard. In other embodiments, network port 132 may comprise a digital subscriber line (DSL) modem, cable modem, or other broadband communications system operable to connect the information processing system 100 to the physical network. In these embodiments, the physical network 134 may comprise the public switched telephone network (PSTN), the public Internet, a corporate intranet, a virtual private network (VPN), or any combination of telecommunication technologies and protocols operable to establish a network connection for the exchange of information.

In another embodiment, communications controller 130 is likewise physically coupled to bus 150 and is further coupled to wireless personal area network (PAN) modem 136. In turn, PAN modem 136 further couples the information processing system 100 to one or more wireless PAN networks 138. In one embodiment, wireless PAN network 138 is based on technologies such as Bluetooth or Ultra Wideband (UWB). In another embodiment, communications controller 130 is coupled to wireless local area network (WLAN) modem 140. In turn, WLAN modem 140 further couples the information processing system 100 to one or more WLANs 142, such as those based on variations of the IEEE 802.11 specification, often referred to as WiFi. In yet another embodiment, communications controller 130 is coupled to wireless wide area network (WWAN) modem 144. In turn, WWAN modem 144 further couples the information processing system 100 to one or more WWANs 146, such as those based on an industry standard including two and a half generation (2.5G) wireless technologies such as general packet radio service (GPRS) and enhanced data rates for GSM evolution (EDGE). In other embodiments, WWAN network 146 comprises WWANs based on existing third generation (3G) wireless technologies including universal mobile telecommunications system (UMTS) and wideband code division multiple access (W-CDMA). Other embodiments also comprise the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies.

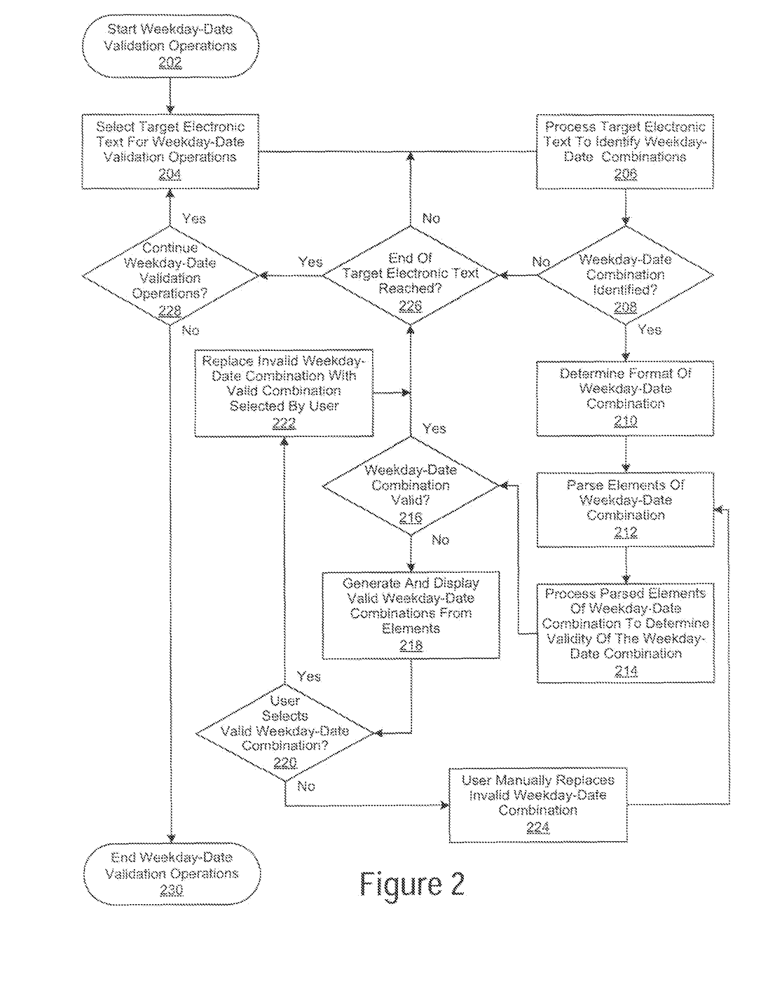

FIG. 2 is a generalized flowchart of the operation of a weekday-date validation module as implemented in an embodiment of the invention for validating weekday and date combinations in electronic text. In this embodiment, operations to validate weekday-date combinations within an electronic text are begun in step 202, followed by the selection of a target electronic text in step 204. In step 206, the target electronic text is processed to identify weekday-date combinations. In various embodiments, the target electronic text is received within a user interface. In one embodiment, the target electronic text has been generated before it is received within the user interface for processing. In another embodiment, the target electronic text is processed as it is entered within the user interface by a user. A determination is then made in step 208 whether a weekday-date combination has been identified. If not, then a determination is made in step 226 if the end of the target electronic text has been reached. If not, then the process is continued, proceeding with step 206. Otherwise, a determination is made in step 228 whether to continue operations to validate weekday-date combinations within a target electronic text. If so, then the process is continued, proceeding with step 204. Otherwise, operations to validate weekday-date combinations within an electronic text are ended in step 230.

However, if it is determined in step 208 that a weekday-date combination has been identified, then the format of the weekday-date combination is determined in step 210. In various embodiments, the weekday-date combination comprises a plurality of weekday-date formats. As an example, the weekday-date combination of “Wednesday, Mar. 4, 2009” may be variously formatted as “Wednesday, 3/4/2009,” “Wednesday, 3/4/09,” “Wed., 3/4/09,” or “W 2009-03-04.” Skilled practitioners of the art will be aware that many such weekday-date formats exist and the foregoing is not intended to limit the spirit, scope, or intent of the invention. Then, in step 212, individual data elements of the weekday-date combination are parsed. As an example, the weekday-date combination of “Wednesday, Mar. 3, 2009” may be parsed as weekday=‘Wednesday,’ month=‘March,’ day=‘3’, and year=‘2009.’ The parsed weekday-date data elements are then processed in step 214 to determine the validity of the weekday-date combination. To further the prior example, the parsed weekday-date data elements of weekday=‘Wednesday,’ month=‘March,’ day=‘3; and year=‘2009’ result in an invalid weekday-date combination when processed.

A determination is then made in step 216 whether the weekday-date combination is valid. If so, then the process is continued, proceeding with step 226. Otherwise, valid weekday-date combinations are generated from the parsed weekday-date data elements and then displayed to the user within a user interface in step 218. In various embodiments, the valid weekday-date combinations comprise a plurality of different weekday data elements and a plurality of different date data elements. As an example, the valid weekday-date combinations of “Tuesday, Mar. 3, 2009,” “Wednesday, Mar. 4, 2009,” and “Wednesday, Mar. 11, 2009” may be generated and displayed within a user interface as replacements for the invalid weekday-date combination of “Wednesday, Mar. 3, 2009.” In various other embodiments, the valid weekday-date combinations comprise the same weekday data element and a plurality of different date data elements. As an example, the weekday data element “Wednesday” may be combined with date data elements of “Mar. 4, 2009,” “Mar. 11, 2009,” “Mar. 18, 2009,” “Mar. 25, 2009,” and “Apr. 2, 2009” to generate valid weekday-date combinations.

Once the valid weekday-date combinations are generated and displayed to the user within a user interface in step 218, a determination is made in step 220 whether the user selects a valid weekday-date combination to replace the invalid weekday-date combination. If so, then the invalid weekday-date combination is replaced in step 222 within the electronic text with the valid weekday-date combination selected by the user. The process is then continued, proceeding with step 226. However, if it is determined in step 220 that the user does not select a valid weekday-date combination, then the user manually enters a weekday-date combination within the user interface in step 224 to replace the invalid weekday-date combination. The process is then continued, proceeding with step 212.

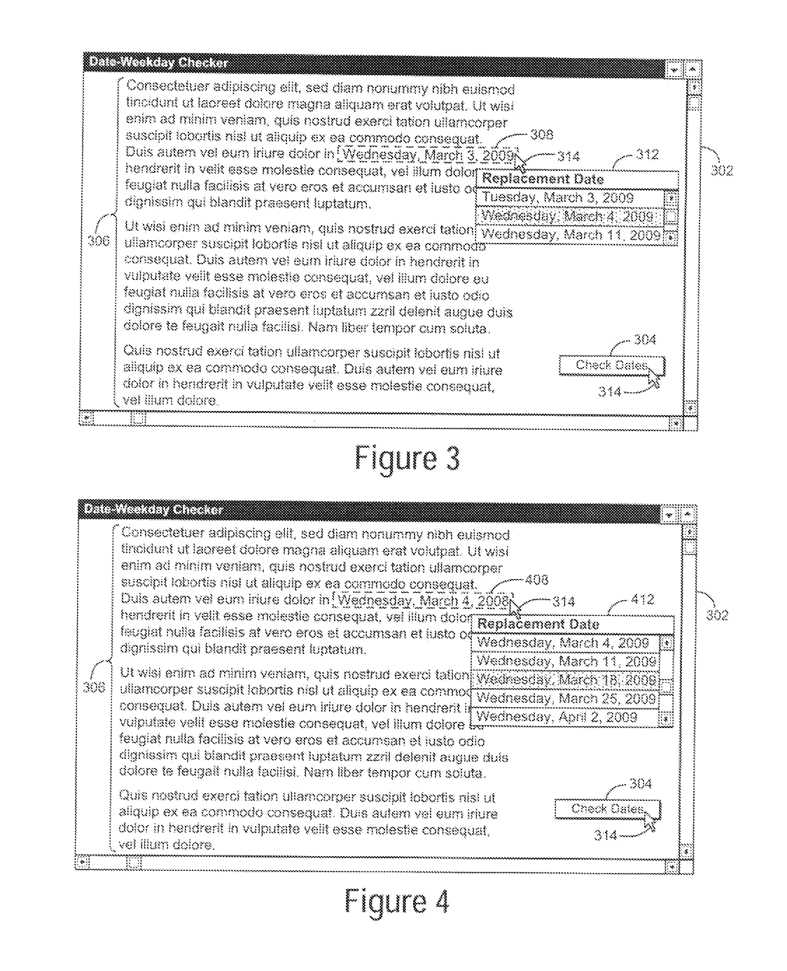

FIG. 3 is a simplified illustration of a weekday-date validation module as implemented within a window of a user interface in accordance with a first embodiment of the invention for validating weekday and date combinations in electronic text. In this embodiment, a user interface window 302 of a weekday-date module comprises electronic text 306, ‘Replacement Date’ menu 312, and a ‘Check Dates’ 304 command button. As described in greater detail herein, the processing of electronic text 306 is initiated with a user gesture, such as a mouse-click with cursor 314 on the ‘Check Dates’ 304 command button. The electronic text 306 is then processed to identify an invalid weekday-date combination 308 with a value of “Wednesday, Mar. 3, 2009.” The weekday-date combination 308 is then further processed to parse its associated weekday and date data elements. The resulting parsed weekday and date data elements are then processed to generate valid weekday-date combinations, which are then displayed in the ‘Replacement Date’ menu 312. The user then selects a valid weekday-date combination (e.g., Wednesday, Mar. 4, 2009) through a user gesture, such as a mouse-click with cursor 314. The selected valid weekday-date combination is then used to replace the invalid weekday-date combination 308 of “Wednesday, Mar. 3, 2009).”

FIG. 4 is a simplified illustration of a weekday-date validation module as implemented within a window of a user interface in accordance with a second embodiment of the invention for validating weekday and date combinations in electronic text. As illustrated in FIG. 4, electronic text 306 comprises an invalid weekday-date combination 408 with a value of “Wednesday, Mar. 4, 2008.” As described in greater detail herein, the weekday-date combination 408 is processed to parse its associated weekday and date data elements. The resulting parsed weekday and date data elements are then further processed to generate valid weekday-date combinations, which are then displayed in the ‘Replacement Date’ menu 412. In this embodiment, the valid weekday-date combinations comprise the same weekday data element and a plurality of different date data elements. More specifically, the weekday data element “Wednesday” is combined with date data elements of “Mar. 4, 2009,” “Mar. 11, 2009,” “Mar. 18, 2009,” “Mar. 25, 2009,” and “Apr. 2, 2009” to generate valid weekday-date combinations. The user then selects a valid weekday-date combination (e.g., Wednesday, Mar. 18, 2009) through a user gesture, such as a mouse-click with cursor 314. The selected valid weekday-date combination is then used to replace the invalid weekday-date combination 308 of “Wednesday, Mar. 4, 2008).”

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for validating weekday and date combinations in electronic text, comprising processing logic operable to:
receive text data comprising a weekday data and date data combination, said text data displayed within a user interface;
process said text data to determine an invalid weekday data and date data combination;
generate a plurality of valid weekday data and date data combinations;
display within said user interface said plurality of valid weekday data and date data combinations;
receive user input data within said user interface, said input data comprising selection data to select one of said plurality of valid weekday data and date data combinations; and
replace said invalid weekday data and date data combination with said selected valid weekday data and date data combination.

2. The system of claim 1, wherein:
said text data is received as user input data within said user interface; and
said text data is processed to determine said invalid weekday data and date data combination as said user input data is received.

3. The system of claim 1, wherein said invalid weekday data and date data combination is replaced by a valid weekday data and date data combination received as user input data within said user interface.

4. The system of claim 1, wherein said plurality of valid weekday data and date data combinations comprises the same weekday data element and a plurality of different date data elements.

5. The system of claim 1, wherein said weekday data comprises a plurality of weekday data formats.

6. The system of claim 1, wherein said date data comprises a plurality of date data formats.

7. A computer-implemented method for validating weekday and date combinations in electronic text, comprising:
using processing logic to receive text data comprising a weekday data and date data combination, said text data displayed within a user interface;
using processing logic to process said text data to determine an invalid weekday data and date data combination;
using processing logic to generate a plurality of valid weekday data and date data combinations;
using processing logic to display within said user interface said plurality of valid weekday data and date data combinations;
using processing logic to receive user input data within said user interface, said input data comprising selection data to select one of said plurality of valid weekday data and date data combinations; and
using processing logic to replace said invalid weekday data and date data combination with said selected valid weekday data and date data combination.

8. The method of claim 7, wherein:
said text data is received as user input data within said user interface; and
said text data is processed to determine said invalid weekday data and date data combination as said user input data is received.

9. The method of claim 7, wherein said invalid weekday data and date data combination is replaced by a valid weekday data and date data combination received as user input data within said user interface.

10. The method of claim 7, wherein said plurality of valid weekday data and date data combinations comprises the same weekday data element and a plurality of different date data elements.

11. The method of claim 7, wherein said weekday data comprises a plurality of weekday data formats.

12. The method of claim 7, wherein said date data comprises a plurality of date data formats.

13. A computer-usable medium embodying computer program code, the computer program code comprising computer executable instructions configured for:
using processing logic to receive text data comprising a weekday data and date data combination, said text data displayed within a user interface;
using processing logic to process said text data to determine an invalid weekday data and date data combination;
using processing logic to generate a plurality of valid weekday data and date data combinations;
using processing logic to display within said user interface said plurality of valid weekday data and date data combinations;
using processing logic to receive user input data within said user interface, said input data comprising selection data to select one of said plurality of valid weekday data and date data combinations; and
using processing logic to replace said invalid weekday data and date data combination with said selected valid weekday data and date data combination.

14. The computer-usable medium of claim 13, wherein:
said text data is received as user input data within said user interface; and
said text data is processed to determine said invalid weekday data and date data combination as said user input data is received.

15. The computer-usable medium of claim 13, wherein said invalid weekday data and date data combination is replaced by a valid weekday data and date data combination received as user input data within said user interface.

16. The computer-usable medium of claim 13, wherein said plurality of valid weekday data and date data combinations comprises the same weekday data element and a plurality of different date data elements.

17. The computer-usable medium of claim 13, wherein said weekday data comprises a plurality of weekday data formats.

18. The computer-usable medium of claim 13, wherein said date data comprises a plurality of date data formats.
